(19) United States
(12) Patent Application Publication
(10) Pub. No.: US 2014/0196156 A1
(43) Pub. Date: Jul. 10, 2014

(54) CAPTURING AND MANIPULATING CONTENT USING BIOMETRIC DATA

(71) Applicant: INTERNATIONAL BUSINESS MACHINES CORPORATION, Armonk, NY (US)

(72) Inventors: DAvid Bruce Lection, Raleigh, NC (US); Ruthie D. Lyle, Raleigh, NC (US); Eric Leonard Masselle, Raleigh, NC (US)

(73) Assignee: International Business Machines Corporation, Armonk, NY (US)

(21) Appl. No.: 13/738,853

(22) Filed: Jan. 10, 2013

(51) Int. Cl. G06F 21/60; G06F 21/00

(52) U.S. Cl. CPC G06F 21/60
USPC 726/28

(57) ABSTRACT

A method, system, and computer program product for capturing and manipulating content using biometric data are provided in the illustrative embodiments. Biometric data is received from a biometric sensor associated with the data processing system, the biometric data forming a first biometric data. The content is received, the content being captured using the data processing system by a first user associated with the first biometric data. The content is modified using information from a first profile associated with the first biometric data.

### TECHNICAL FIELD

The present invention relates generally to a computer implemented method, system, and computer program product for capturing and manipulating various types of content. More particularly, the present invention relates to a computer implemented method, system, and computer program product for capturing and manipulating content using biometric data.

### BACKGROUND

A variety of types of content is captured using a variety of devices. For example, a camera captures image content, a microphone captures audio content, a video camera or a camcorder captures audio and video content, and an electrocardiogram machine captures electrical signal content.

Typically, a user operates a device to capture content. Often, multiple users can operate the same device to capture content, perhaps at different times or places. The device may store the content or transmit the content over a data network for storage or manipulation on another device, such as for storage on network attached storage (NAS), for printing on a printer, or display on a monitor.

### SUMMARY

The illustrative embodiments provide a method, system, and computer program product for capturing and manipulating content using biometric data. An embodiment receives the biometric data from a biometric sensor associated with the data processing system, the biometric data forming a first biometric data. The embodiment receives the content, the content being captured using the data processing system by a first user associated with the first biometric data. The embodiment modifies the content using information from a first profile associated with the first biometric data.

### BRIEF DESCRIPTION OF THE SEVERAL VIEWS OF THE DRAWINGS

The novel features believed characteristic of the embodiments are set forth in the appended claims. An embodiment of the invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts an example device, a camera, modified to capture biometric data in accordance with an illustrative embodiment;

FIG. 4 depicts an example device, a microphone, modified to capture biometric data in accordance with an illustrative embodiment;

FIG. 5 depicts a block diagram of an application for using biometric data in conjunction with content in accordance with an illustrative embodiment;

FIG. 6 depicts a block diagram of an example operation of a biometric application in accordance with an illustrative embodiment;

FIG. 7 depicts a flowchart of an example process of new user registration in accordance with an illustrative embodiment;

FIG. 8 depicts a flowchart of an example process of using biometric data in accordance with an illustrative embodiment; and

FIG. 9 depicts a flowchart of another example process of using biometric data in accordance with an illustrative embodiment.

### DETAILED DESCRIPTION

An embodiment of the invention recognizes that identifying the user who captures or manipulates content using a device may be beneficial. For example, different users of a device may wish to enforce different restrictions on the content being captured using the device. For example, one user may want to share the pictures that user captures whereas another user may not want to share the pictures that user captures using the same camera. As another example, one user may wish to restrict the use of the pictures taken by the user to only viewing but not transmitting the picture by another user. Users may wish to enforce many other similarly principled restrictions, conditions, or preferences within the scope of the illustrative embodiments. Identifying the user who is capturing or manipulating the content using a particular device may be useful for enforcing such restrictions, conditions, or preferences on the content.

An embodiment further recognizes that identifying a user who is capturing or manipulating content using a device may be useful in other ways. For example, it may be desirable to configure the device differently for different users. For example, one user may prefer using the flash on a camera at full power setting whereas another user may prefer using the flash at half power setting. As another example, one user may prefer to add reverberation effect to the voice when using a microphone, whereas another user may prefer to add no effects at all when using the same microphone. Devices may be configured differently using many other similarly principled characteristics, specifications, or features within the scope of the illustrative embodiments. Identifying the user who is capturing or manipulating the content using a particular device may be useful for configuring such characteristics, specifications, or features on the device.

An embodiment further recognizes that identification of the user for these and other similar purposes can be accomplished by using the user's biometric data. Fingerprints, retina image, facial image, breath contents, smell, contents of sweat and other fluids and secretions, posture, and gait are some examples sources of biometric data about a user. Presently, biometric sensors are available for sensing one or more types of biometric data.

An embodiment further recognizes that the biometric data collection or sensing can be intrusive to the activity that the user may be performing. For example, presently, a user may have to overtly contact or interface with a biometric sensor to provide the biometric data and then proceed with the normal actions of the desired activity. Typically, providing the biometric data is an overt act on the part of the user, the overt act being distinct from actions involved in the desired activity.

An embodiment further recognizes that acquiring the biometric information in a manner that uses an action already a part of the user's desired activity is advantageous for various reasons. For example, by integrating the sensing of biometric data into the actions of the desired activity, the user may not learn how the user is being identified, thereby thwarting identity spoofing. As another example, when repeated identification is necessary, such as for pictures being captured in quick succession, the user may not slow down to overtly provide the biometric data each time before proceeding to perform the desired activity.

The illustrative embodiments used to describe the invention generally address and solve the above-described problems and other problems related to different users capturing and manipulating content using one or more devices. The illustrative embodiments provide a method, system, and computer program product for capturing and manipulating content using biometric data.

Generally, the illustrative embodiments provide various ways of integrating biometric sensors in various devices for sensing biometric data from users, preferably without requiring a separate action on the part of the user. For example, an illustrative embodiment may integrate a fingerprint scanner in that surface of the shutter of a camera that receives the depressing action from a user's index finger. As another example, an illustrative embodiment may integrate a voice sampler into a microphone that receives the sound generated from the user's mouth. As another example, an illustrative embodiment may integrate a retina scanner into an eyepiece of a camera where a user may place his or her eye for framing the picture being captured.

The illustrative embodiments further provide various ways of capturing and manipulating content using the biometric data. For example, content can be tagged with the capturing user's profile information, such as the user's name, social media identifier, or a combination of these and other user-specific information. As another example, content can be restricted for use or manipulation based on the capturing user's preferences.

The illustrative embodiments further provide various ways of automatically configuring a device or a characteristic of the device based on the biometrically identified user's preferences. For example, a camera can be put in auto mode, aperture mode, or shutter speed mode based on the biometrically identified user's preferences from the user's profile.

The illustrative embodiments are described with respect to certain devices only as examples. Such descriptions are not intended to be limiting on the illustrative embodiments. For example, an illustrative embodiment described with respect to a camera can be implemented using a device to capture visual content, audio content, motion video content, electrical signals, magnetic signals, infrared data, textual data, or content in any other form within the scope of the illustrative embodiments.

Similarly, the illustrative embodiments are described with respect to certain biometric data and sensors only as examples. Such descriptions are not intended to be limiting on the illustrative embodiments. For example, an illustrative embodiment described with respect to a fingerprint data or fingerprint scanner can be implemented using a biometric sensor to capture any other suitable biometric data within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the embodiments of the invention.

The illustrative embodiments are further described with respect to certain applications only as examples. Such descriptions are not intended to be limiting on the embodiments of the invention. An embodiment of the invention may be implemented with respect to any type of application, such as, for example, applications that are served, the instances of any type of server application, a platform application, a stand-alone application, an administration application, or a combination thereof.

An application, including an application implementing all or part of an embodiment, may further include data objects, code objects, encapsulated instructions, application fragments, services, and other types of resources available in a data processing environment. For example, a Java® object, an Enterprise Java Bean (EJB), a servlet, or an applet may be manifestations of an application with respect to which an embodiment of the invention may be implemented. (Java and all Java-based trademarks and logos are trademarks or registered trademarks of Oracle and/or its affiliates).

An illustrative embodiment may be implemented in hardware, software, or a combination thereof. An illustrative embodiment may further be implemented with respect to any type of data storage resource, such as a physical or virtual data storage device, that may be available in a given data processing system configuration.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

The illustrative embodiments are described using specific code, designs, architectures, layouts, schematics, and tools only as examples and are not limiting on the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

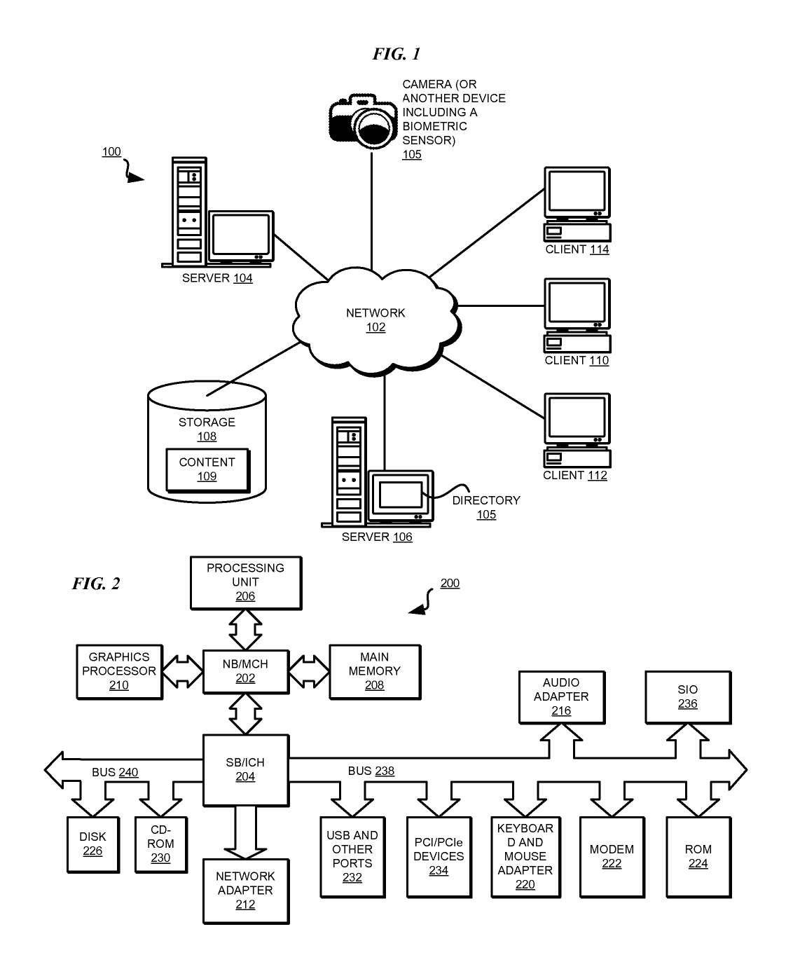

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Device 105 is depicted as a camera, but is not limited thereto. Device 105 may be any device suitable for capturing content and modified to include a biometric data collection mechanism in accordance with an illustrative embodiment. Any data processing system, such as storage 108, may include content 109. Content 109 may have been captured, modified, or otherwise manipulated using device 105 in accordance with an illustrative embodiment. For example, even device 105 may store content 109 (not shown).

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes of the illustrative embodiments may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States, other countries, or both), or Linux® (Linux is a trademark of Linus Torvalds in the United States, other countries, or both). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle and/or its affiliates).

Program instructions for the operating system, the object-oriented programming system, the processes of the illustrative embodiments, and applications or programs are located on storage devices, such as hard disk drive 226, and may be loaded into a memory, such as, for example, main memory 208, read only memory 224, or one or more peripheral devices, for execution by processing unit 206. Program instructions may also be stored permanently in non-volatile memory and either loaded from there or executed in place. For example, the synthesized program according to an embodiment can be stored in non-volatile memory and loaded from there into DRAM.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

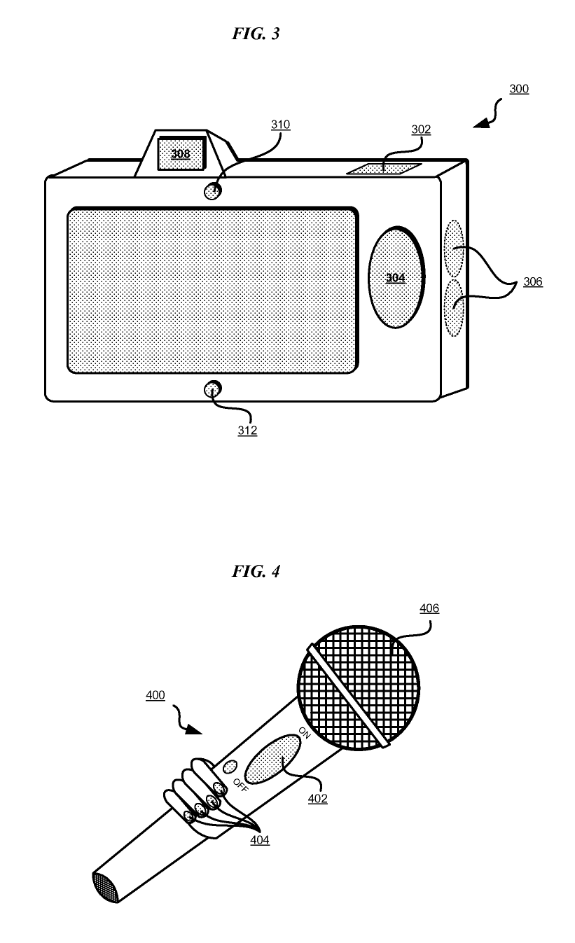

With reference to FIG. 3, this figure depicts an example device, a camera, modified to capture biometric data in accordance with an illustrative embodiment. Camera 300 may be an example of device 105 in FIG. 1.

Camera 300 is shown to include several biometric sensors, any combination of which may be implemented in a given implementation of the illustrative embodiment. For example, sensor 302 may be a fingerprint scanner integrated into the shutter (not shown) of camera 300. A user using camera 300 for capturing a picture will depress the shutter, perhaps with the index finger, and consequently allow sensor 302 to scan the user's fingerprint from the index finger.

Sensor 304 may be a fingerprint scanner integrated into the body of camera 300. A user using camera 300 for capturing a picture will hold the body such that the user's thumb is likely to be placed to sensor 304. Consequently, sensor 304 may scan the user's fingerprint from the user's thumb.

Sensors 306 may be one or more fingerprint scanners integrated into the body of camera 300. A user using camera 300 for capturing a picture will hold the body such that the user's middle and ring fingers are likely to be placed to sensors 306. Consequently, sensors 306 may scan the user's fingerprint from the user's middle finger, ring finger, or a combination thereof. More or fewer sensors 306 may further allow scanning the user's index finger and little finger as well. Alternatively, sensors 306 may be sweat sensors that may scan the palm sweat of the user while the user holds the camera for capturing a picture.

Sensor 308 may be a retina scanner integrated into the eyepiece of camera 300. A user using camera 300 for capturing a picture will hold the camera up to the user's eye, placing the user's eye within readable distance and position of sensor 308. Consequently, sensor 308 may scan the user's retina from the user's eye. Note that the placement of such a sensor is not limited to an eyepiece on the camera. Where a camera does not include an eyepiece, a similar sensor may be placed in other suitable location on the camera within the scope of the embodiment.

Sensor 310 may be a camera integrated into the back cover of camera 300. A user using camera 300 for capturing a picture will hold the camera up placing the user's face within readable distance and position of sensor 310. Consequently, sensor 310 may scan the user's face or facial expression as the user's biometric data.

Sensor 312 may be a gas analyzer integrated into the body of camera 300. A user using camera 300 for capturing a picture will hold the camera up placing the user's nose and mouth within readable distance and position of sensor 312. Consequently, sensor 312 may scan the user's breath or vapors emanating from the user's nose or mouth.

Sensors 302-312 are described and depicted only as examples without implying any limitation on the illustrative embodiment. Any other sensor can be similarly integrated in a suitable position on camera 300 or another device within the scope of the illustrative embodiments.

With reference to FIG. 4, this figure depicts an example device, a microphone, modified to capture biometric data in accordance with an illustrative embodiment. Microphone 400 may be an example of device 105 in FIG. 1.

Microphone 400 is shown to include several biometric sensors, any combination of which may be implemented in a given implementation of the illustrative embodiment. For example, sensor 402 may be a fingerprint scanner integrated into the On-Off button of microphone 400. A user using microphone 400 for amplifying or recording the user's voice will operate the switch, perhaps with the user's thumb, and consequently allow sensor 402 to scan the user's fingerprint from the user's thumb.

Sensors 404 may be one or more fingerprint scanners integrated into the body of microphone 400. A right-handed user using microphone 400 for amplifying or recording the user's voice will hold microphone 400 in such a way that one or more of the right hand fingers will fall on sensors 404. Consequently sensors 404 may scan the user's fingerprint from one or more of the user's right hand fingers.

A left-handed implementation of microphone 400 may use different placement of sensors 402 and 404. An implementation of microphone 400 may position sensors 402 or 404 such that microphone 400 can be used by right-handed as well as left-handed users.

Sensor 406 may be a voice sampler integrated into the diaphragm enclosure of microphone 400. A user using microphone 400 for capturing the user's voice will speak into microphone 400, consequently offering the user's voice for sampling by sensor 406.

As with camera 300 in FIG. 3, sensors 402-404 are described and depicted only as examples without implying any limitation on the illustrative embodiment. Any other sensor can be similarly integrated in a suitable position on microphone 400 or another device within the scope of the illustrative embodiments.

Furthermore, camera 300, microphone 400, or another device for capturing or manipulating content can be suitably shaped to cause the user to be oriented in a suitable position relative to the device for providing the biometric information without performing an overt act there for. For example, microphone 400 may have finger groves molded into the body of microphone 400, with sensors 404 embedded into the groves, inviting the user to place the fingers into the groves as opposed to elsewhere on the body of microphone 400. As another example, while not necessary, an On-Off switch may be integrated into microphone 400, with a fingerprint sensor embedded therein, to cause the user to turn the microphone On and consequently offer a fingerprint.

With reference to FIG. 5, this figure depicts a block diagram of an application for using biometric data in conjunction with content in accordance with an illustrative embodiment. Device 502 may be analogous to device 105 in FIG. 1, such as camera 300 in FIG. 3, or microphone 400 in FIG. 4.

Biometric application 504 is an application that captures, records, and uses the biometric data being collected by one or more biometric sensors integrated with device 502. Capture component 506 is a component of biometric application 504 responsible for reading, accepting, filtering, processing, or otherwise manipulating the biometric data from a user. Authentication or registration component 508 uses the biometric data captured by capture component 506 for recognizing the user or registering a new user. Use component 510 modifies the content being captured, manipulates device 502's configuration, or a combination thereof, using the biometric data.

Users of device 502 that wish to partake of the features and capabilities of an illustrative embodiment register with device 502. When a previously unknown biometric data is captured by capture component 506, device 502 may automatically go into a registration mode, or the user offering the new biometric data may select a registration mode on device 502. Additionally, registration according to an embodiment may include entry of a name, a voice sample, a picture of the user, or a combination thereof, which may be incorporated into a profile for that user. The user's profile may further include additional information about the user, such as the user's social networking identifiers, and any settings or configuration of device 502 preferred by the user. For example, a user may configure a ‘timeout’ period after which the latest instance of authorization based on the user's biometric data captured by device 502 is void, new biometric data should be captured and the user re-authenticated.

Once registered, the user may operate device 502, and information from the user's profile is used to authenticate or recognize the user, configure device 502, modify the content captured by the user using device 502, or a combination thereof. For example, when device 502 is a camera and the user captures a picture using the camera, the user's identifying information entered at registration is associated with the picture. According to one embodiment, this association can take the form of metadata, an extractable watermark, or other suitable tagging of the image data of the picture.

In an initial state, device 502 may have no profiles configured therein, and may not allow a user to proceed with using device 502 until a profile is created. Alternatively, device 502 may have a default profile that configures device 502 in a default configuration.

Any number of users can register with device 502 without limitation. Furthermore, a user can create multiple profiles on device 502 and a profile for the same user may modify the content, the device, or both differently relative to another profile for the user. For example, a user may register with the user's index finger fingerprint to cause a camera device to be in full-auto mode, and with the middle finger fingerprint to cause the camera to be in an aperture mode.

The user's profile is either created or retrieved when authentication or registration component 508 successfully registers or authenticates a user from the user's captured biometric data. Use component 510 may use certain information in a user's profile to modify the content that the user captures with device 502. For example, the information from the user's profile may determine which users can perform which operations on which content. Using a camera as an example of device 502, a first user can select from among other registered users to determine who can view, delete, or download the photos taken by the first user. Device 502 may then filter the first user's content so that when other users attempts to access the first user's content, only those users authorized by the first user can manipulate that content.

In one embodiment, an unregistered user, or a registered user avoiding biometric authentication may capture content using device 502. Such content, however, may be available for all users of device 502 without restrictions.

In another embodiment, device 502 may disallow an unregistered user from using device 502, thereby acting as security against unauthorized use of device 502. In another embodiment, biometric application 504 may capture the biometric data of any unregistered users and save that biometric data together with the content captured or manipulated by the unregistered user. If/when the unregistered user registers, biometric application 504 may match that content that was captured or manipulated while the user was unregistered, with the recently registered user.

An embodiment may cause a registered user's authentication to timeout. For example, a user may specify a timeout in the user's profile, or biometric application 504 may configure a default timeout in a user's profile.

In one embodiment, the timeout period may be used for maintaining device 502's configuration according to the user's profile before reverting to another configuration, such as a default configuration. A user may have to re-authenticate upon the expiry of the timeout period.

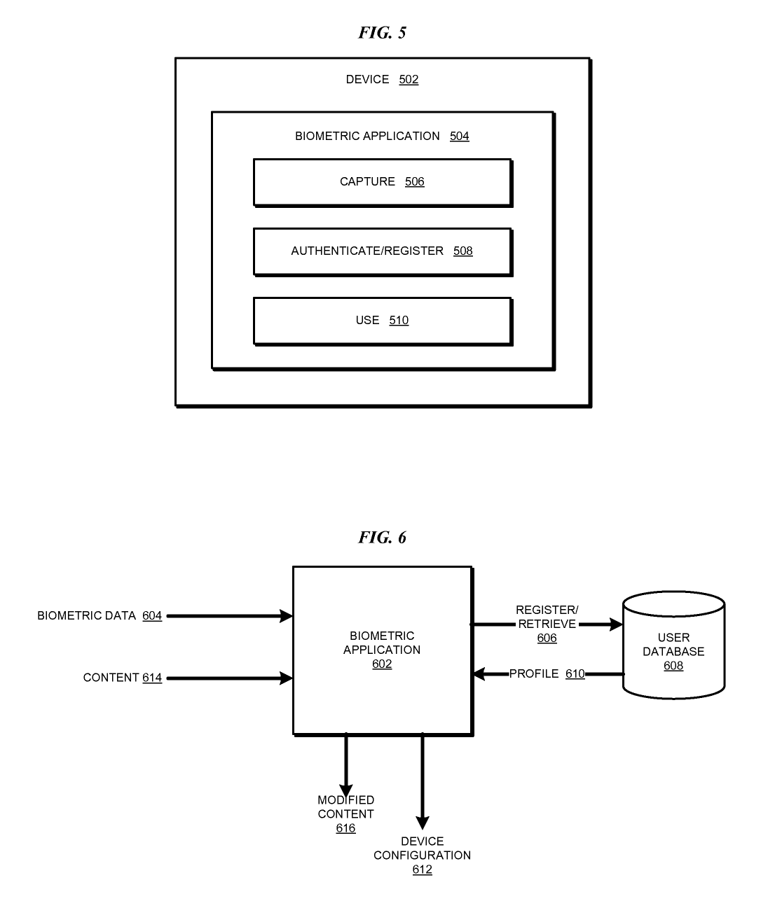

With reference to FIG. 6, this figure depicts a block diagram of an example operation of a biometric application in accordance with an illustrative embodiment. Biometric application 602 is similar to biometric application 504 in FIG. 5.

Biometric application 602 receives biometric data 604, such as a fingerprint scan from a fingerprint scanner. Biometric application 602 registers or retrieves 606 a user profile associated with biometric data 604 from user database 608. User database 608 may be a repository of user profiles in any suitable form, including but not limited to relational databases, flat files, index files, or a combination thereof.

User database 608 returns profile 610 to biometric application 602. Biometric application 602 performs device configuration 612 using information from profile 610. Biometric application 602 receives content 614, content 614 being content captured or manipulated by the user associated with biometric data 604. Biometric application 602 outputs modified content 616. Modified content 616 may be content 614 with the user's identifying information associated therewith, content 614 restricted for manipulation by other users according to the user's profile, content 614 stored or modified in other ways as specified in the user's profile—such as being stored for a limited period and then deleted, or a combination thereof.

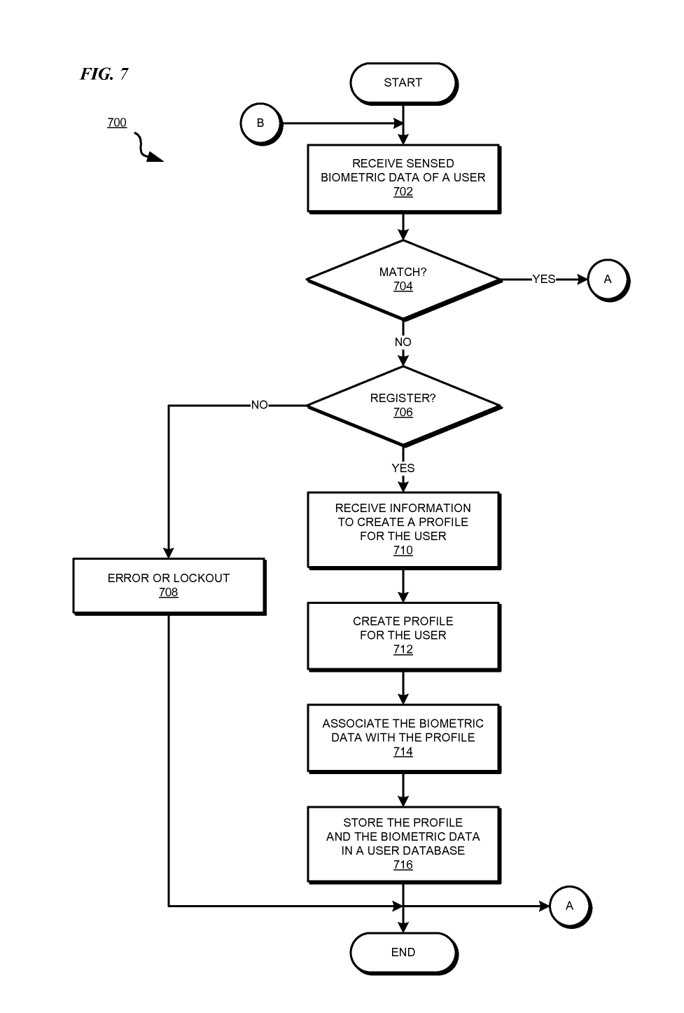

With reference to FIG. 7, this figure depicts a flowchart of an example process of new user registration in accordance with an illustrative embodiment. Process 700 may be implemented using biometric application 602 in FIG. 6.

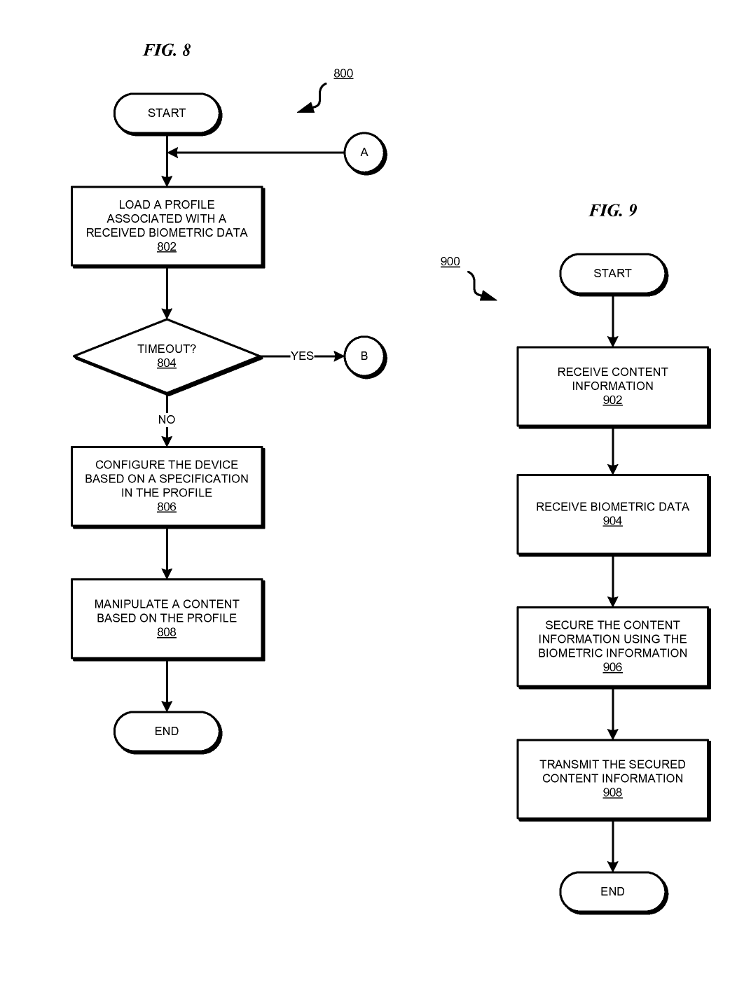

Process 700 begins by receiving sensed biometric data of a user, such as from a biometric sensor (step 702). Another process, such as process 800 in FIG. 8, may enter process 700 at entry point marked “A”.

Process 700 determines whether the biometric data of step 702 matches with biometric data associated with any known user profile, such as a profile stored in user database 608 in FIG. 6 (step 704). If a match is found (“Yes” path of step 704), process 700 exits at exit point marked “A”, to enter another process, such as process 800 in FIG. 8, to omit registration and perform further actions using the biometric data of step 702.

If a match is not found (“No” path of step 704), such as when the biometric data of step 702 is from a new user or when a registered user is creating a new profile with a different biometric data, process 700 determines whether to register the user providing the biometric data (step 706). If a new registration is not to be created (“No” path of step 706), process 700 may generate an error, lock the use of the device, or a combination thereof (step 708). Process 700 may end thereafter. Another alternative (not shown) after the “No” path of step 706 may be that the device operates in a default configuration and the user cannot take advantage of a profile, automatic custom settings, security of the content, or a combination thereof. In other words, the device may allow the user to proceed to capture content as an unregistered user.

The “No” path of step 706 may be traversed, for example, when the device is limited in the number of user profiles that can be created and that limit has been reached. As another example, the “No” path of step 706 may be traversed when an administrator of the device has suspended or locked the new registration feature of the device.

If a new registration can be created (“Yes” path of step 706), process 700 receives the information to create the user profile (step 710). For example, process 700 may accept further inputs from the user to populate the profile. As another example, process 700 may allow the user to select certain content from the device, such as a picture on a camera device, to include in the profile.

Process 700 creates a profile for the user using the information (step 712). Process 700 associates the biometric data of step 702 with the profile (step 714). Process 700 stores the profile and the biometric data in a user database (step 716). Process 700 may end thereafter or having completed the registration process, exit at exit point marked “A”, to enter another process, such as process 800 in FIG. 8, and perform further actions using the biometric data of step 702.

With reference to FIG. 8, this figure depicts a flowchart of an example process of using biometric data in accordance with an illustrative embodiment. Process 800 may be implemented in biometric application 602 in FIG. 6.

Process 800 begins by loading a profile associated with a received biometric data (step 802). Another process, such as process 700 in FIG. 7, may enter process 800 at entry point marked “A”. The received biometric data of step 802 may be received in step 702 in FIG. 7.

Process 800 determines whether a previous authentication (match) based on the biometric data has timed out (step 804). If the authentication has timed out (“Yes” path of step 804), process 800 exits at exit point marked “B” to enter another process, such as process 700 in FIG. 7 at a corresponding entry point marked “B”.

If the authentication has not timed out (“No” path of step 804), process 800 may optionally configure the device based on a specification in the profile associated with the biometric data (step 806). Process 800 captures, manipulates, or both, the content for the user associated with the biometric data based on the user's profile (step 808). Process 800 ends thereafter.

With reference to FIG. 9, this figure depicts a flowchart of another example process of using biometric data in accordance with an illustrative embodiment. Process 900 may be implemented in biometric application 602 in FIG. 6.

Process 900 begins by receiving content information, such as content 614 in FIG. 6 (step 902). Process 900 receives or retrieves biometric data (step 904). Process 900 secures the content information using the biometric data (step 906). Process 900 transmits the secured content information (step 908). Process 900 ends thereafter.

As an example of the operation of process 900, assume that process 900 is executing in a camera device and processing image content being captured by a registered user. When the registered user captures a picture, process 900 may encrypt the picture using the registered user's biometric data as an encryption key. For performance reasons, an embodiment may postpone the encryption until the picture content is ready for download, when new picture capturing activity has stopped, or some other specified event has occurred or not occurred. The registered user of a captured picture can specify how to modify, restrict, or secure the picture. The registered user can do so universally for all of the user's content by specifying the modification, restriction, or security feature in the user's profile, or specifically on a content-by-content basis.

For example, content may be secured such that no download of the content by other users is permitted. As another example, content may be secured such that download is permitted only of the content that is encrypted with the user's biometric key, and the content is not usable without decrypting with the user's biometric data. As another example, content may be secured such that download is permitted if the downloading user encrypts the content with their own biometric data and the content is usable by decrypting with the downloading user's biometric data. As another example, content may be secured such that content may be downloaded with no encryption for a defined period, to a defined data processing system, by an identified user or group, or a combination thereof.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for capturing and manipulating content using biometric data. Using an embodiment of the invention, a device can be configured to include biometric sensors such that biometric data can be captured from a user without requiring any over action of submitting the biometric data on the user's part. Furthermore, the biometric data can be used for authenticating the user, marking, or modifying the content with the user's information, securing the content belonging to the user, configuring the device according to the user's preferences, or a combination thereof.

An embodiment may further allow a user to create multiple profiles on the same device using different biometric information. Different profiles may allow the user to perform different modifications of the user's content, or secure the content in different ways. Different profiles may also allow a user to configure the device differently for capturing or manipulating content.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for capturing and manipulating content using biometric data in a data processing system, the method comprising:
receiving the biometric data from a biometric sensor associated with the data processing system, the biometric data forming a first biometric data;
receiving the content, the content being captured using the data processing system by a first user associated with the first biometric data; and
modifying the content using information from a first profile associated with the first biometric data.

2. The computer implemented method of claim 1, wherein the modifying adds information identifying the first user to the content.

3. The computer implemented method of claim 1, wherein the modifying secures the content using the first user's first biometric data.

4. The computer implemented method of claim 3, wherein the modifying secures the content by encrypting the content using the first biometric data as an encryption key.

5. The computer implemented method of claim 1, wherein the modifying restricts access to the content to a group of users, the group including the first user and a second user.

6. The computer implemented method of claim 1, wherein the modifying prevents a second user from performing a manipulation on the content.

7. The computer implemented method of claim 6, wherein the manipulation includes deleting the content.

8. The computer implemented method of claim 6, wherein the manipulating includes downloading the content.

9. The computer implemented method of claim 8, wherein the downloading is performed after the content is encrypted with a second biometric data of a second user.

10. The computer implemented method of claim 1, further comprising:
changing a configuration of the data processing system using a specification in the first profile.

11. The computer implemented method of claim 1, wherein the first user is associated with a second profile, the second profile is associated with a third biometric data, the second biometric data is distinct from the third biometric data, and the second and the third biometric data are associated with the first user.

12. The computer implemented method of claim 1, wherein the data processing system is a camera, the biometric sensor is a fingerprint scanner, and the first biometric data is a fingerprint scan of the first user.

13. The computer implemented method of claim 1, further comprising:
authenticating the first user using the first biometric data, the authenticating including matching successfully the first biometric data with a second biometric data associated with the first profile, the first profile being stored in a user database.

14. The computer implemented method of claim 13, wherein when the matching is unsuccessful, further comprising:
determining whether to create a new profile using the first biometric data;
creating, responsive to the determining being affirmative, creating the new profile, the creating including associating the first biometric data with the new profile; and
disabling access to the data processing system responsive to the determining being negative.

15. A computer usable program product comprising a computer usable storage medium including computer usable code for capturing and manipulating content using biometric data in a data processing system, the computer usable code comprising:
computer usable code for receiving the biometric data from a biometric sensor associated with the data processing system, the biometric data forming a first biometric data;
computer usable code for receiving the content, the content being captured using the data processing system by a first user associated with the first biometric data; and
computer usable code for modifying the content using information from a first profile associated with the first biometric data.

16. The computer usable program product of claim 15, wherein the modifying adds information identifying the first user to the content.

17. The computer usable program product of claim 15, wherein the modifying secures the content using the first user's first biometric data.

18. The computer usable program product of claim 15, wherein the computer usable code is stored in a computer readable storage medium in a data processing system, and wherein the computer usable code is transferred over a network from a remote data processing system.

19. The computer usable program product of claim 15, wherein the computer usable code is stored in a computer readable storage medium in a server data processing system, and wherein the computer usable code is downloaded over a network to a remote data processing system for use in a computer readable storage medium associated with the remote data processing system.

20. A data processing system for capturing and manipulating content using biometric data in a data processing system, the data processing system comprising:
a storage device including a storage medium, wherein the storage device stores computer usable program code; and
a processor, wherein the processor executes the computer usable program code, and wherein the computer usable program code comprises:
computer usable code for receiving the biometric data from a biometric sensor associated with the data processing system, the biometric data forming a first biometric data;
computer usable code for receiving the content, the content being captured using the data processing system by a first user associated with the first biometric data; and
computer usable code for modifying the content using information from a first profile associated with the first biometric data.
